(19) United States
(12) Patent Application Publication
(10) Pub. No.: US 2013/0298758 A1
(43) Pub. Date: Nov. 14, 2013

(54) DIAPHRAGM DEVICE AND PRESSURE CONTROL RESERVOIR USING THE SAME

(71) Applicants: ADVICS CO., LTD., Kariya-shi (JP); DENSO CORPORATION, Kariya-shi (JP)

(72) Inventors: Kazuma SHIGETA, Kariya-shi (JP); Kouji AOBA, Kariya-shi (JP)

(73) Assignees: DENSO CORPORATION, Kariya-shi (JP); ADVICS CO., LTD., Kariya-shi (JP)

(21) Appl. No.: 13/872,611

(22) Filed: Apr. 29, 2013

(30) Foreign Application Priority Data
May 11, 2012 (JP) 2012-109505

(51) Int. Cl. F16J 3/02

(52) U.S. Cl. CPC F16J 3/02
USPC 92/48

(57) ABSTRACT

A diaphragm device that supports a diaphragm with sandwiching an annular attaching portion, in an axis direction, provided at outer circumference of a flexible film by the support member having a diaphragm mounting portion, wherein at least three protrusions are provided at an outer circumference of the annular attaching portion, and each of the at least three protrusions equally protrudes in a radial direction, and wherein when the annular attaching portion is compressed in the axis direction, each of the at least three protrusions contacts with an inner circumference of the diaphragm mounting portion which faces an outer circumference of the annular attaching portion.

### CROSS-REFERENCE TO RELATED APPLICATION

This application claims priority from Japanese Patent Application No. 2012-109505 filed on May 11, 2012, the entire subject matter of which is incorporated herein by reference.

### TECHNICAL FIELD

This disclosure relates to a diaphragm device to generate a driving force by using pressure differences (pressure difference) oppositely acting on both surfaces of a flexible film, or to balance pressures of chambers facing both surfaces of the flexible film, and a reservoir for a brake apparatus using the same.

### BACKGROUND

An example of a diaphragm device is disclosed in JP-A-2011-208675. The diaphragm device disclosed in JP-A-2011-208675 includes a flexible film and an annular attaching portion (referred to as an outer circumference flange portion) provided on a circumference edge of the flexible film, where the outer circumference flange portion is axially sandwiched between a first housing and a second housing while being compressed therebetween.

The annular attaching portion is also served as a seal member, and is fixed to a diaphragm by being sandwiched between the first and second housings, so that communication between two chambers defined by the diaphragm is interrupted.

An object of the diaphragm disclosed in JP-A-2011-208675 is to secure an accurate initial moving attitude by suppressing distorted deformation of the annular attaching portion and a uplift of the flexible film from a support surface according to the distorted deformation. In order to achieve the object, while the annular attaching portion is being sandwiched between the first and second housings, a gap is formed between an inner circumference (outer circumference wall) of a diaphragm mounting portion of the first housing and the annular attaching portion.

### SUMMARY

In the structure where the gap is formed between the inner circumference of the diaphragm mounting portion and the annular attaching portion while the annular attaching portion is being sandwiched between the first and second housings, like the diaphragm disclosed in JP-A-2011-208675, a relatively large gap is formed between the annular attaching portion and the inner circumference of the diaphragm mounting portion when the annular attaching portion is in a free state without being compressed.

Under this situation, there is a degree of freedom in radial movement in the diaphragm received in the diaphragm mounting portion, so that the centering precision of the diaphragm is deteriorated.

If the diaphragm is fixed at a position deviated from the center of the housing according to the poor centering precision of the diaphragm, each portion of the flexible film may not be deformed uniformly when the pressure difference between the two chambers defined is applied thereto.

If the attached position of the diaphragm is imprecision, a portion of the annular attaching portion may be pressed against the inner circumference of the diaphragm mounting portion when the annular attaching portion is compressed in the axial direction, so that the diaphragm may be distorted. Further, if the diaphragm is thermally expanded, for example, the flexible film may be not distorted uniformly. Under this situation, the uniform deformation of each portion of the flexible film is more deteriorated, so that the performance of the diaphragm device becomes more unstable.

In view of the above, this disclosure is provided to fix stably a diaphragm of a diaphragm device to a center of an attaching portion with a high centering characteristic.

In view of the above, a diaphragm device of this disclosure supports a diaphragm with sandwiching an annular attaching portion, in an axis direction, provided at outer circumference of a flexible film by the support member having a diaphragm mounting portion. At least three protrusions are provided at an outer circumference of the annular attaching portion, and each of the at least three protrusions equally protrudes in a radial direction, and when the annular attaching portion is compressed in the axis direction, each of protrusions contacts with an inner circumference of the diaphragm mounting portion which faces an outer circumference of the annular attaching portion.

Other aspects of a diaphragm device of this disclosure are listed as below.
(1) In the above-described diaphragm device of this disclosure, when the annular attaching portion is compressed and fixed, the protrusions come into contact with the inner circumference of the diaphragm mounting portion of the support member and other portions of the annular attaching portion except for the protrusions may be spaced apart from the inner circumference of the diaphragm mounting portion.
(2) In the above-described diaphragm device of this disclosure, in a free state where the annular attaching portion may be not compressed, the protrusions are spaced apart from the inner circumference of the diaphragm mounting portion.
(3) In the above-described diaphragm device of this disclosure, the annular attaching portion is configured as a flange including an inner circumference protruding in the axis direction from an end face of the flexible film, and when the annular attaching portion is compressed and fixed, the inner circumference is spaced apart from a circumferential wall of the diaphragm mounting portion which faces the inner circumference.
(4) In the above-described diaphragm device of this disclosure, each protrusion may be formed in a convex circular shape as viewed from a plan view.
(5) In the above-described diaphragm device of this disclosure, each protrusion may be formed as a ridge extending from one end of the annular attaching portion in the axis direction to the other end thereof.
(6) In the above-described diaphragm device of this disclosure, three or four protrusions are installed at an equal interval in a circumferential direction.

This disclosure also provides a pressure control reservoir for a brake apparatus. The pressure control reservoir for a brake apparatus comprises: a diaphragm supported with sandwiching an annular attaching portion, in an axis direction, provided at outer circumference of a flexible film by the support member having a diaphragm mounting portion, wherein at least three protrusions are provided at an outer circumference of the annular attaching portion, and each of the at least three protrusions equally protrudes in a radial direction, the flexible film configured to divide an interior of a cylinder installed in a housing into a fluid storage chamber and an atmosphere chamber; a piston, which is slidably inserted into the cylinder and which supports the diaphragm from a side of the atmosphere chamber; a spring configured to bias the piston toward the fluid storage chamber from the atmosphere chamber; a movable plate, which is accommodated in the fluid storage chamber and provided on an end face of the flexible film in the fluid storage chamber; and a check valve, which is disposed in a communication passage between the fluid storage chamber and a reservoir hole, wherein the piston is provided with a through-hole to communicate one side of the flexible film with the atmosphere chamber, wherein when a pressure of the fluid storage chamber is lower than that of the atmosphere chamber, the flexible film swells toward the fluid storage chamber, and then the movable plate is pressed and moved, so that the check valve is opened by a displacement force of the movable plate, and wherein the piston serves as the support member, wherein when the annular attaching portion is compressed in the axis direction, each of protrusions contacts with an inner circumference of the diaphragm mounting portion which faces an outer circumference of the annular attaching portion.

According to the diaphragm device of this disclosure, the plurality of protrusions are equally provided at the outer circumference of the annular attaching portion of the diaphragm, each of which protrudes in the radial direction, so that the gap formed between the tip portions of the protrusions and the inner circumference of the support member is to be narrowed by the height (radial dimension) of the protrusion in the free state where the annular attaching portion is not compressed in the axial direction, as compared with the diaphragm disclosed in JP-A-2011-208675 described above.

Here, an expansion amount of an inner diameter of the annular attaching portion which is caused by the compression in the axis direction is referred as t, and the gap formed between the annular attaching portion and the inner circumference of the support member under a situation where the annular attaching portion is compressed in the axis direction for the purpose of suppressing the distortion (securing an escape) is referred as Δt, and thus a diameter d of the annular attaching portion in the free state is necessarily set by d=D−(t+Δt) at a maximum level, in which a diameter of the inner circumference of the support member is D.

In the diaphragm device of this disclosure, when the annular attaching portion is in the free state, the gap formed between the tip portion of the protrusion and the inner circumference becomes a dimension obtained by subtracting the height of the protrusion from the gap (t+Δt) for the diaphragm with no protrusion.

The gap can be made smaller as much as possible (the gap can have even a zero value) since it is not installed for the purpose of suppressing the distortion of the annular attaching portion. Accordingly, the centering precision is improved by the above-described protrusions when the diaphragm is assembled. Therefore, misalignment of the attached position becomes small, and unevenness deformation of each portion of the flexible film which is caused by the position misalignment is suppressed, thereby stabilizing the characteristic of the device.

In a diaphragm device where the annular attaching portion is compressed and fixed and where the protrusions come into contact with the inner circumference of the diaphragm mounting portion, while other portions of the annular attaching portion except for the protrusions are spaced apart from the inner circumference of the diaphragm mounting portion, the outer circumference of the annular attaching portion is not restrained by the inner periphery surface of the diaphragm mounting portion at the time of compression, so that the distortion of the annular attaching portion or the flexible film by compression is suppressed.

Further, in a diaphragm device where the protrusions are spaced apart from the inner circumference of the diaphragm mounting portion when the annular attaching portion is in the free state, the diaphragm can be mounted on the diaphragm mounting portion without a trouble, so that the protrusions are not elastically deformed at the time of mounting.

The protrusions contact with the inner circumference of the diaphragm mounting portion when the annular attaching portion is compressed in the axis direction. At that time, it is preferable that the amount of the protrusions to be pressed in the radial direction is smaller. However, the distortion of the diaphragm caused by the deformation of protrusions is remarkably small, as compared with the distortion when the annular attaching portion is pressed against the inner circumference of the diaphragm mounting portion, the deformation of the protrusions has a small effect on the characteristic of the diaphragm.

Further, in a diaphragm device where the annular attaching portion is configured as a flange including an inner circumference protruding in the axis direction from an end face of the flexible film and the inner circumference is spaced apart from a circumferential wall of the diaphragm mounting portion which faces the inner circumference when the annular attaching portion is compressed and fixed, the inner circumference of the annular attaching portion is not pressed against the circumferential wall, thereby suppressing the distortion of the diaphragm due to the pressing.

Further, the clearance of the annular attaching portion for, for example, thermally expansion is also secured on the inner circumference side of the diaphragm mounting portion, so that the distortion caused by the expansion is suppressed.

Meanwhile, in a diaphragm device where a protrusion is formed in the convex circular shape as viewed from a plan view, the protrusion comes into contact with the inner circumference of the diaphragm mounting portion in a state similar to a point and a line. Therefore, a reaction force when the protrusions are compressed in the radial direction is suppressed to be small, as compared with the surface contact of the protrusions. Further, in a diaphragm device where the protrusion is formed as the ridge, the reaction force uniformly applied on each region of the outer circumference of the annular attaching portion in the axis direction when the protrusions are compressed in the radial direction. Therefore, these configuration have the effect of suppressing the distortion of the diaphragm.

In a case where at least three protrusions are provided, the centering effect is achieved. It is preferable that the protrusions are arranged to be symmetrical to the center, in view of centering precision. Meanwhile, since it is preferable that the number of the protrusions is small to suppress the distortion of the flexible film, the number of the provided protrusions may be limited to three or four. In either case, it may be preferable that the protrusions are arranged at an equal interval in the circumferential direction.

The pressure control reservoir of this disclosure includes the diaphragm device in which the distortion of the flexible film is suppressed to be zero or small, so that opening and closing of the check valve is reliably performed without causing a timing difference or the like.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a perspective view illustrating one example of a diaphragm for use in a diaphragm device of this disclosure;

FIG. 2 is an enlarged plan view of a protrusion forming portion of the diaphragm;

FIG. 3 is a cross-sectional view of the diaphragm in FIG. 1 taken along the line III-III in FIG. 2;

FIG. 4 is a cross-sectional view of a diaphragm mounting portion of the diaphragm device using the diaphragm in FIG. 1;

FIG. 5 is a cross-sectional view of the diaphragm mounting portion in a case where the diaphragm is fixed to the diaphragm mounting portion;

FIG. 6 is a cross-sectional view illustrating major parts of another example of the diaphragm for use in the diaphragm device of this disclosure; and

FIG. 7 is a cross-sectional view illustrating one example of a pressure control reservoir for a brake apparatus of this disclosure.

### DETAILED DESCRIPTION

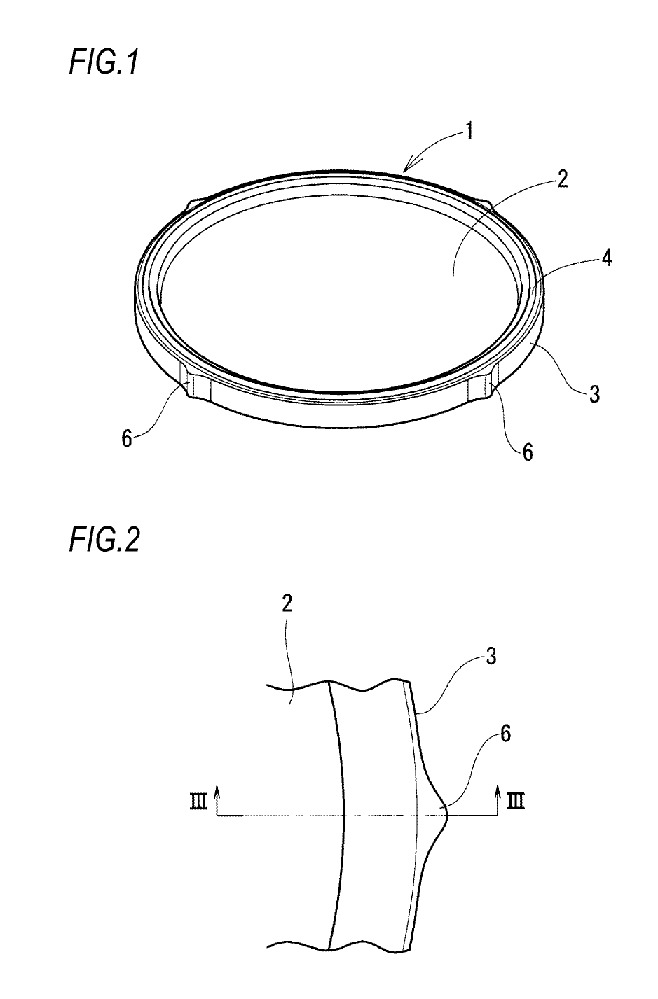

Now, an illustrative embodiment of a diaphragm device and a pressure control reservoir according to this disclosure will be described with reference to FIGS. 1 to 7.

FIGS. 1 to 3 illustrates one example of a diaphragm assembled into the diaphragm device of this disclosure. A diaphragm 1 is made of rubber and includes a flexible film 2 and an annular attaching portion (annular base portion) 3 formed integrally with an outer circumference of the flexible film. For example, EPDM (Ethylene-Prophylene-Diene Monomer) having a good oil resistance is employed as a material of the rubber.

The flexible film 2 is a film to divided into two chambers which causes a pressure difference. The annular attaching portion 3 is configured as a flange protruding toward one side of the flexible film 2, and is illustrated to have ridges 4 and 5 which are provided at one end and the other end in an axial direction and which are continuously provided in a circumferential direction. When the annular attaching portion 3 is sandwiched between support members 10 (see FIGS. 4 and 5) configuring the diaphragm device 13, the ridges 4 and 5 are compressed in the axial direction, and then are pressed against a sealed surface of the support member 10, so that communication of the two divided chambers is interrupted at the position.

In this instance, the ridges 4 and 5 are disclosed in JP-A-2011-208675 described above, and this disclosure is not characterized by the protrusions.

The support member 10 includes members illustrated in FIGS. 4 and 5, that is, a first member 11 having a seat surface 11a supporting one side of the annular attaching portion 3 and an inner circumference 11b (inner circumference of the diaphragm mounting portion), and a second member 12 inserted in the first member 11 and fixed to the first member 11 at a position where the annular attaching portion 3 is compressed at a prescribed amount. The diaphragm 1 is held by both the first member 11 and the second member 12 to configure the diaphragm device 13 of this disclosure.

The outer circumference of the annular attaching portion 3 is provided with a plurality (four in the diaphragm illustrated herein) of protrusions 6 having the same size at an equal interval in a circumferential direction, the protrusions 6 protruding to have the same amount in a radial direction. The minimum number of the protrusions 6 is three. Further, the illustrated shape in which the protrusions 6 are arranged to be symmetrical to the center is preferable in view of good centering characteristic.

In a case where the annular attaching portion 3 is compressed in an axis direction by sandwiching the annular attaching portion 3 between the support members 10 and thus is fixed to the diaphragm mounting portion, a tip portion of the protrusion comes into contact with the inner circumference 11b of the diaphragm mounting portion (see FIG. 5). In this instance, other portions of the annular attaching portion 3 except for the portions of the protrusions 6 are maintained in a state where the other portions are spaced apart from the inner circumference 11b of the diaphragm mounting portion.

Further, in a free state where the annular attaching portion 3 is not compressed, the protrusions 6 is configured to be spaced apart from the inner circumference 11b of the diaphragm mounting portion, as illustrated in FIG. 4. Therefore, the mounting of the diaphragm 1 to the diaphragm mounting portion can be performed without a trouble.

The annular attaching portion 3 of the diaphragm illustrated herein is configured as a flange having an inner circumference 3a protruding in the axis direction from an end face of the flexible film 2. Even when the annular attaching portion 3 is compressed and fixed, the inner circumference 3a is spaced apart from a circumferential wall 12a (surface opposite to the inner circumference 3a) of the diaphragm mounting portion formed on the second member 12. This configuration also effect to suppress the distortion of the flexible film.

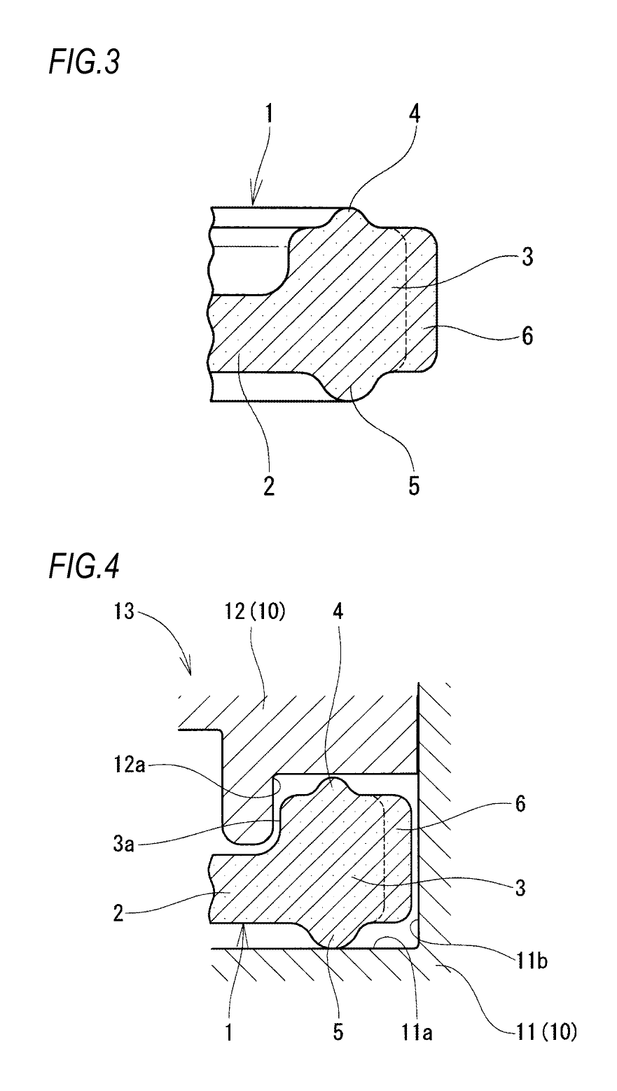

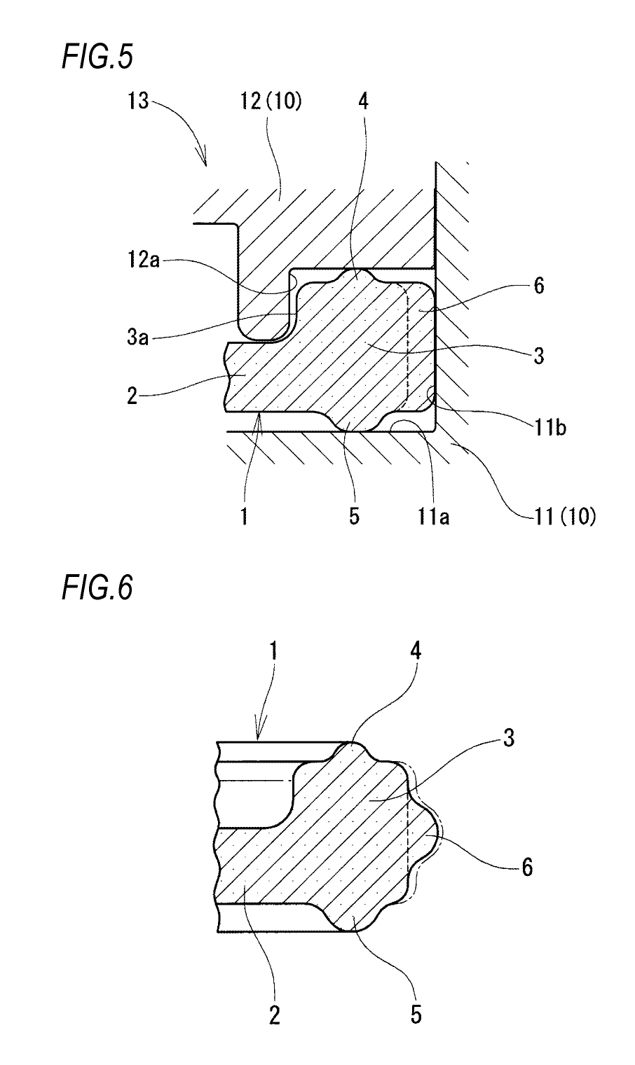

The protrusion 6 is formed as a ridge extending from one end of the annular attaching portion 3 in the axis direction to the other end thereof, as illustrated in FIGS. 1 and 3. Therefore, a reaction force caused when the protrusions 6 are compressed in the radial direction is dispersed over a wide region of the outer circumference of the annular attaching portion. However, as illustrated in FIG. 6, the object of installation is achieved by the protrusions that provided as point shapes at the axial center portion of the outer circumference of the annular attaching portion 3.

The protrusion 6 illustrated herein is formed in a convex circular shape as viewed from a plan view and comes into contact with the inner circumference of the diaphragm mounting portion in a state similar to a point or a line. Accordingly, as compared with a surface contact with the protrusion, the reaction force is suppressed to be small when the protrusions are compressed in the radial direction. There is an effect on the distortion suppression of the diaphragm.

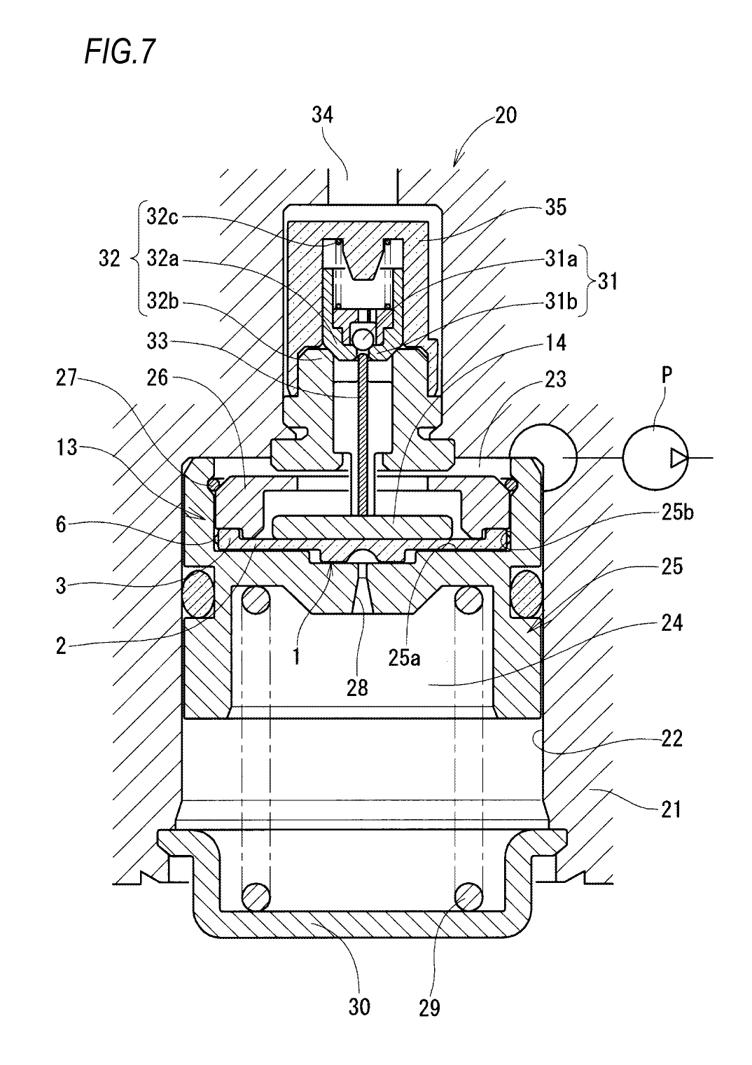

One example of the pressure control reservoir employing the above-described diaphragm device 13 of this disclosure is illustrated in FIG. 7. The pressure control reservoir 20 is employed in the brake apparatus of a vehicle having an electronic control function, and includes a cylinder 22 installed in a housing 21, and a piston 25, which is freely slidable in the cylinder to partition a fluid storage chamber 23 and an atmosphere chamber 24.

The piston 25 is also served as the first member which is described and illustrated in FIGS. 4 and 5, and has a seat surface 25a and an inner circumference 25b. Also, the piston 25 has a press member 26 corresponding to the second member which is described and illustrated in FIGS. 4 and 5, and a locking member 27 (C-shaped ring in the drawing). The press member 26 is inserted in the piston 25 so that the annular attaching portion 3 of the diaphragm 1 is sandwiched between the seat surface 25a formed at the piston 25 and the press member 26. The locking member 27 holds the press member 26 inserted in the piston 25 at a determined position.

The piston 25 and the press member 26 serve as the support member 10 in FIGS. 4 and 5, and the above-described diaphragm 1 with the protrusions 6 formed on the outer circumference of the annular attaching portion 3 is interposed between the piston 25 and the press member 26 to configure the diaphragm device 13.

The diaphragm device 13 includes a movable plate 14. Further, a partition wall of the piston 25 to partition the fluid storage chamber 23 and the atmosphere chamber 24 is provided with a through-hole 28 to communicate one side of the flexible film 2 with the atmosphere chamber 24.

As well as the above elements, the pressure control reservoir 20 illustrated herein includes a spring 29 biasing the piston 25 toward the fluid storage chamber 23, a spring receiver 30 mounted on an inlet of the atmosphere chamber 24 and serving as a cover, a check valve 31 for a small-diameter oil passage, a check valve 32 for a large-diameter oil passage, a push-up pin 34, and a filter 35.

The check valve 31 is provided as necessary, and it is a well-known valve combined by a ball valve 31a and a valve seat 31b. The check valve 32 is also a well-known valve combined by a valve body 32a, a valve seat 32b which is brought into contact with and is separated from the valve body 32a, and a spring 32c biasing the valve body in a valve closing direction.

The pressure control reservoir 20 configured as described above connects a reservoir hole 34 with a master reservoir (not illustrated) via a master cylinder of the brake apparatus for the vehicle, and connects the fluid chamber 23 with a discharge passage (not illustrated) of a brake fluid from a wheel cylinder and an inlet port of a pump P which is driven by a command from the electronic control device, respectively.

The pressure control reservoir 20 temporarily receives the brake fluid discharged from the wheel cylinder of the vehicle using the fluid storage chamber 23. If the pump P is driven based on the command from the electronic control device, the pump P pumps and discharges the brake fluid accumulated in the pressure control reservoir 20.

When the pressure of the fluid storage chamber 23 is lower than that of the atmosphere chamber 24 (if it becomes negative pressure) while the pump P is being driven, the flexible film 2 of the diaphragm device swells upwardly due to a pressure difference between the fluid storage chamber 23 and the atmosphere chamber 24, and thus the movable plate 14 is lifted to move push-up pin 33 up. As the push-up pin 33 pushes the ball valve 31a up, the check valve 31 for the small-diameter oil passage is opened to control the pressure of the fluid storage chamber 23. Further, when the pressure of the reservoir hole 34 is lower, force is transmitted via the ball valve 31a of the check valve 31 for the small-diameter oil passage to open the check valve 32 for the large-diameter oil passage. Therefore, it is possible to increase a sectional area of the passage when the pump P pumps the brake fluid of the master reservoir of the brake apparatus.

Since the other operation is well known, the detailed description thereof will be omitted herein.

What is claimed is:

1. A diaphragm device that supports a diaphragm with sandwiching an annular attaching portion, in an axis direction, provided at outer circumference of a flexible film by the support member having a diaphragm mounting portion,
wherein at least three protrusions are provided at an outer circumference of the annular attaching portion, and each of the at least three protrusions equally protrudes in a radial direction, and
wherein when the annular attaching portion is compressed in the axis direction, each of the at least three protrusions contacts with an inner circumference of the diaphragm mounting portion which faces an outer circumference of the annular attaching portion.

2. The diaphragm device according to claim 1,
wherein when the annular attaching portion is compressed and fixed, the protrusions come into contact with the inner circumference of the diaphragm mounting portion of the support member and other portions of the annular attaching portion except for the protrusions are spaced apart from the inner circumference of the diaphragm mounting portion.

3. The diaphragm device according to claim 1,
wherein, in a free state where the annular attaching portion is not compressed, the protrusions are spaced apart from the inner circumference of the diaphragm mounting portion.

4. The diaphragm device according to claim 1,
wherein the annular attaching portion is configured as a flange including an inner circumference protruding in the axis direction from an end face of the flexible film, and
wherein when the annular attaching portion is compressed and fixed, the inner circumference is spaced apart from a circumferential wall of the diaphragm mounting portion which faces the inner circumference.

5. The diaphragm device according to claim 1,
wherein each protrusion is formed in a convex circular shape as viewed from a plan view.

6. The diaphragm device according to claim 1,
wherein each protrusion is formed as a ridge extending from one end of the annular attaching portion in the axis direction to the other end thereof.

7. The diaphragm device according to claim 1,
wherein three protrusions are installed at an equal interval in a circumferential direction.

8. The diaphragm device according to claim 1,
wherein four protrusions are installed at an equal interval in a circumferential direction.

9. A pressure control reservoir for a brake apparatus, comprising:
a diaphragm supported with sandwiching an annular attaching portion, in an axis direction, provided at outer circumference of a flexible film by the support member having a diaphragm mounting portion, wherein at least three protrusions are provided at an outer circumference of the annular attaching portion, and each of the at least three protrusions equally protrudes in a radial direction, the flexible film configured to divide an interior of a cylinder installed in a housing into a fluid storage chamber and an atmosphere chamber;
a piston, which is slidably inserted into the cylinder and which supports the diaphragm from a side of the atmosphere chamber;
a spring configured to bias the piston toward the fluid storage chamber from the atmosphere chamber;
a movable plate, which is accommodated in the fluid storage chamber and provided on an end face of the flexible film in the fluid storage chamber; and
a check valve, which is disposed in a communication passage between the fluid storage chamber and a reservoir hole,
wherein the piston is provided with a through-hole to communicate one side of the flexible film with the atmosphere chamber,
wherein when a pressure of the fluid storage chamber is lower than that of the atmosphere chamber, the flexible film swells toward the fluid storage chamber, and then the movable plate is pressed and moved, so that the check valve is opened by a displacement force of the movable plate, and
wherein the piston serves as the support member,
wherein when the annular attaching portion is compressed in the axis direction, each of protrusions contacts with an inner circumference of the diaphragm mounting portion which faces an outer circumference of the annular attaching portion.
